(19) United States
(12) Patent Application Publication
(10) Pub. No.: US 2013/0168120 A1
(43) Pub. Date: Jul. 4, 2013

(54) Guide Device for a Hand-Held Power Tool

(71) Applicants: Aldo Di Nicolantonio, Recherswil (CH); Bernd Altvater, Althuette-Waldenweiler (DE); Andre Hoffmann, Riedholz (CH)

(72) Inventors: Aldo Di Nicolantonio, Recherswil (CH); Bernd Altvater, Althuette-Waldenweiler (DE); Andre Hoffmann, Riedholz (CH)

(73) Assignee: Robert Bosch GmbH, Stuttgart (DE)

(21) Appl. No.: 13/698,928

(22) PCT Filed: Mar. 29, 2011
(86) PCT No.: PCT/EP2011/054840

§ 371 Date: Mar. 6, 2013

(30) Foreign Application Priority Data
May 25, 2010 (DE) 102010029247.8

(51) Int. Cl. B23Q 9/00

(52) U.S. Cl. CPC B23Q 9/0014
USPC 173/184

(57) ABSTRACT

A guide device for hand-held power tools has a guide part which is configured to be placed onto an upper side of a workpiece to be machined. A roller arrangement is held on the guide part and is configured to roll on the workpiece upper side. The roller arrangement has at least one roller which is mounted rotationally on the guide part.

The invention relates to a guide apparatus for a portable power tool according to the preamble of claim 1.

### PRIOR ART

Sole plates on hand-held jigsaws or saber saws are known, said sole plates resting on the workpiece top side in the use position, wherein the saw tool is guided through a through-passage opening in the sole plate. The underside of the sole plate is formed in a planar manner so that there is surface contact between the sole plate and the workpiece top side and the jigsaw is guided in a comparatively stable position and the risk is reduced of the jigsaw accidentally tipping to the side or to the front or rear during machining. However, the surface contact of the sole plate requires a comparatively low-friction workpiece top side, since otherwise there is the risk of the jigsaw being laterally distorted during the advancing movement. This can also be the case when dirt gets between the workpiece top side and the sole plate.

Also known are angle grinders, the grinding tool of which is overlapped by an approximately semicircular protective hood, the underside of which rests against the workpiece surface during machining and slides over the workpiece. In the case of long straight cuts, the cutting quality depends substantially on the capabilities and experience of the user. Irregularities, such as rough surfaces of the workpiece or dirt particles can impair the machining result.

### DISCLOSURE OF THE INVENTION

The invention is based on the object of using simple measures to improve the work result in the machining of a workpiece with a portable power tool.

This object is achieved according to the invention by the features of claim 1. The dependent claims specify expedient developments.

The guide apparatus according to the invention is used for hand-held power tools which have a motor-driven tool, wherein an electric motor is preferably used as the drive device. The guide apparatus is for example a sole plate, in particular in hand jigsaws or saber saws or circular saws that are driven by an electric motor. In a further embodiment, the guide device forms a protective hood which overlaps the tool in a portable power tool, which may be an angle grinder, for example.

The guide apparatus according to the invention comprises firstly a guide part on the underside of the portable power tool, said guide part resting on the workpiece top side during machining. The guide part is arranged preferably next to the tool, in that, in the embodiment of the guide part as a sole plate, the tool is guided through the cutout in the sole plate or, in the embodiment as a protective hood, the tool, for example a cut-off disk, is overlapped.

The guide apparatus furthermore comprises a roller arrangement that rolls on the workpiece and comprises at least one roller mounted in a rotating manner on the guide part. The roller is preferably an individual roller which is mounted in a rotatable manner. The roller can if appropriate also be configured in the form of a roll.

During workpiece machining, the roller arrangement or a part of the roller arrangement rests directly on the workpiece and rolls on the workpiece during an advancing movement. The advancing movement is produced in particular manually by the operator, wherein a motor-driven roller arrangement is also conceivable in principle.

The roller arrangement rolls either over the workpiece top side or, in accordance with a further embodiment, about some other abutment surface of the workpiece, for example a lateral abutment surface, which can be rotated through 90°.

In contrast to embodiments from the prior art, the guide apparatus does not slide over the workpiece surface but rolls thereon, thereby supporting a defined straight-ahead motion. Thus, it is possible, for example, in the case of sawing or grinding machine tools, to carry out long, straight cuts with high dimensional accuracy. The nature of the workpiece surface and the degree of contamination play a much smaller role for the machining quality than is the case in the prior art. Even in the case of different natures of the workpiece top side, the roller arrangement can be guided precisely and at a uniform speed over the workpiece.

The at least one roller, which is a constituent part of the roller arrangement on the guide apparatus, is usually located on the underside of the guide part, said underside facing the workpiece in the use position, wherein, if appropriate, the roller can also project beyond the lateral or front or rear boundary of the guide part, such that the roller is located outside the perimeter of the guide part, but is mounted on the guide part.

In order to ensure slip-free rolling even in the case of smooth, low-friction workpiece surfaces, it may be expedient to provide the rolling part of the roller arrangement with a friction-increasing surface, for example with a rubber coating or a roughened surface structure.

The rolling part of the roller arrangement is, according to a first advantageous embodiment, formed by the roller itself, which rests directly on the workpiece surface during workpiece machining and rolls thereon. According to a further advantageous embodiment, it is provided that a band or a chain wraps around the roller, said band or chain being arranged on the underside of the guide part and being in contact with the workpiece surface during workpiece machining. The band or the chain rolls on the workpiece surface.

According to an expedient development, the guide apparatus has at least two individual rollers which are preferably arranged in an axially offset manner with respect to one another. For example, located at the front and the rear end of the guide part, as seen in the advancing direction, is in each case one individual roller, which is either directly in contact with the workpiece top side or around which there is wrapped a common band or chain which rests on the workpiece. Furthermore, it is possible also to provide in the left-hand and right-hand side region of the guide part—with respect to the advancing direction—in each case rollers, which are either in the form of individual rollers and are in contact with the workpiece, or are assigned in each case an axially offset, second roller, wherein a band or chain wraps around in each case two rollers, said band or chain rolling on the workpiece top side.

According to a further expedient embodiment, a belt wraps around two rollers, which are arranged in an axially offset manner with respect to one another, on the guide part, said belt having the function of synchronizing the rotary movements of the rollers. The belt, which is in the form for example of a toothed belt, thus has no rolling function on the workpiece surface, but merely a function synchronizing rotational speed. Therefore, it is expedient to arrange the belt in a vertically offset manner with respect to the components which come directly into contact with the workpiece surface, in order to avoid direct contact of the belt with the workpiece surface. In this embodiment, the rolling part is formed by the rollers, which are configured as running wheels. Preferably, two running wheels arranged in the left-hand and right-hand side region of the guide part are connected together so as to rotate with one another via a common shaft, wherein the shafts in the front region and in the rear region of the guide part are coupled via the belt.

In the case of a band, a chain or a belt, it may be expedient to mount an additional tension roller in a rotatable manner on the guide apparatus, the band, chain or belt resting against said tension roller. A tensioning force, which prevents sagging of the band, chain or belt, is applied via the tension roller.

Furthermore, it is possible to transmit the movement between two axially offset rollers via a cardan drive or with the aid of gearwheels.

Further advantages and expedient embodiments can be gathered from the further claims, the description of the figures and the drawings, in which:

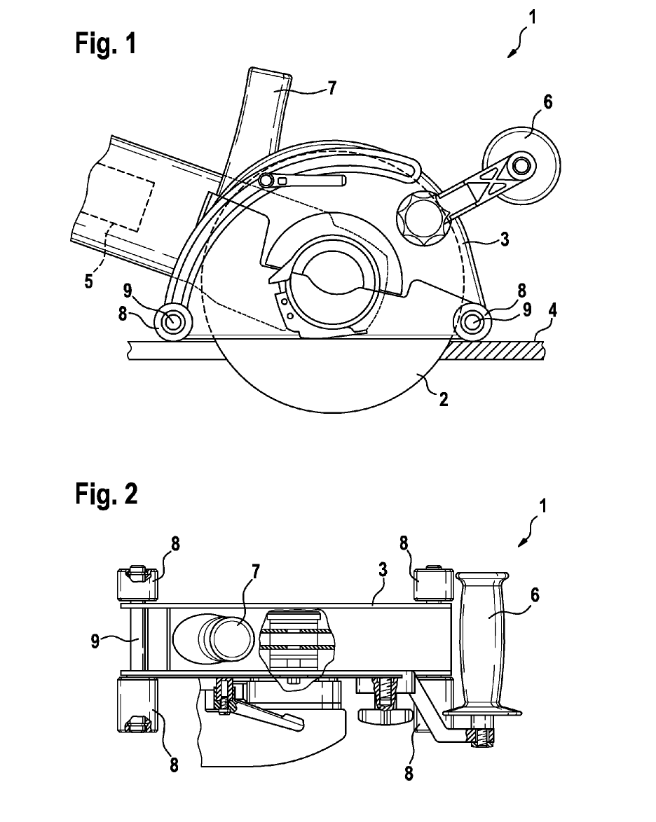

FIG. 1 shows an electric portable power tool configured as an angle grinder, having a protective hood overlapping the tool, said protective hood being provided with rollers in the front and rear regions,

FIG. 2 shows a plan view of the portable power tool from FIG. 1,

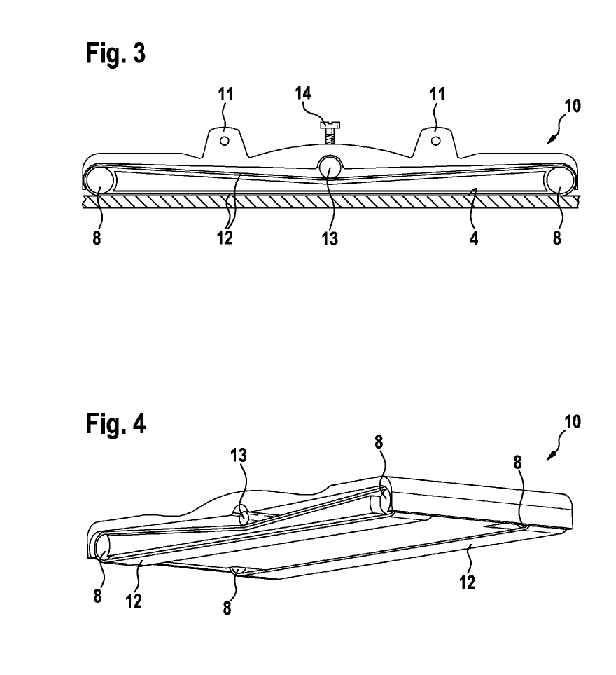

FIG. 3 shows a sole plate for a portable power tool having front and rear rollers, around which a band or a chain is wrapped,

FIG. 4 shows a perspective illustration of the guide apparatus according to FIG. 3,

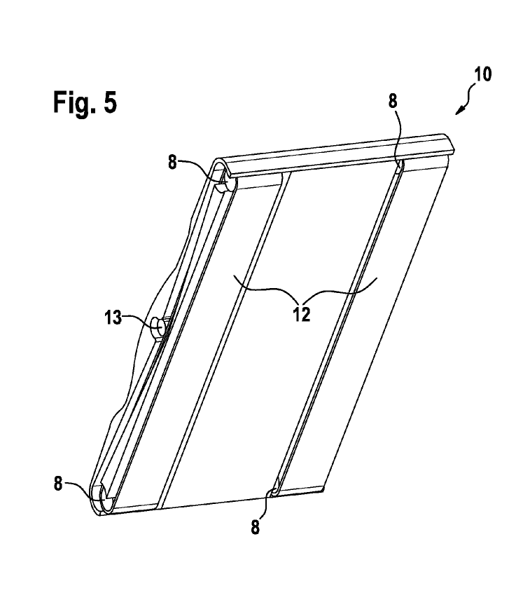

FIG. 5 shows a further perspective view of the guide apparatus,

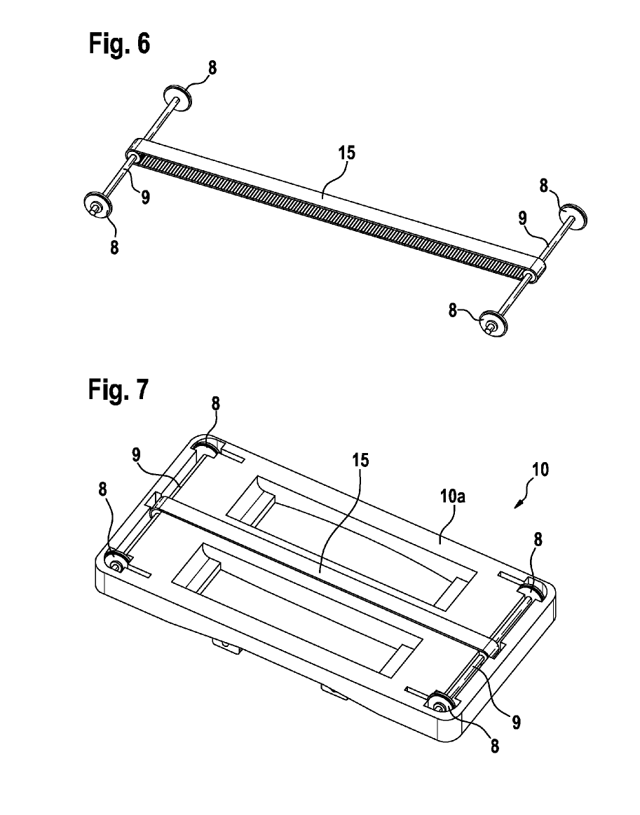

FIG. 6 shows a further exemplary embodiment of a roller arrangement for a guide apparatus of a power tool, wherein the roller arrangement comprises a front shaft and a rear shaft having in each case two rollers and the two shafts are connected via a toothed belt,

FIG. 7 shows the roller arrangement according to FIG. 6 in the installed state in a sole plate,

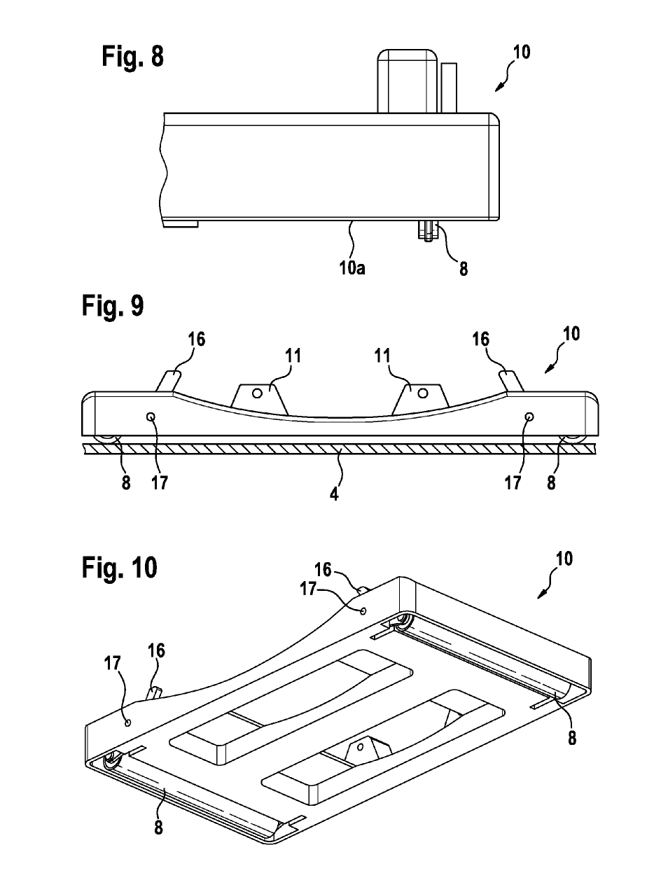

FIG. 8 shows the sole plate in a view from the front,

FIGS. 9 to 12 show various views of a sole plate in a variant embodiment.

In the figures, identical components are provided with identical reference signs.

FIGS. 1 and 2 illustrate an electric portable power tool 1 configured as an angle grinder, the tool 2 of which is configured as a cut-off disk which is overlapped by a semicircular protective hood 3. During workpiece machining, the protective hood 3 rests on the top side 4 of the workpiece; the protective hood 3 thus forms a guide part for guiding the portable power tool on the workpiece. The tool is driven via an electric drive motor 5 and the portable power tool 1 is held and guided via handles 6 and 7.

In the front and rear regions and in each side region of the protective hood 3 there are arranged a total of four rollers 8, which form a roller arrangement for guiding and supporting the protective hood 3 on the workpiece top side 4. In each case one roller 8 mounted in a rotatable manner on the protective hood 3 is located in the front left-hand, front right-hand, rear left-hand and rear right-hand region of the protective hood. In each case two rollers 8 that are arranged in a laterally offset manner with respect to one another are held on a common shaft 9, in particular so as to rotate with one another, wherein an embodiment of the rollers as individual rollers, which are mounted in a rotatable manner independently of one another, is conceivable in principle.

The rollers can also be configured as wheels, which have a smaller width than the rollers in the form of rolls. Since a total of four rollers 8 are provided, the portable power tool 1 is supported stably during workpiece machining and can roll along on the workpiece top side 4 during workpiece machining. In order to prevent slipping in the case of a workpiece surface having a low coefficient of friction, it may be expedient to provide the rollers 8 with a rubber coating or the like in order to increase friction.

FIGS. 3 to 5 illustrate a further exemplary embodiment of a guide apparatus in a portable power tool. The guide apparatus is formed by a sole plate 10, which is used for example in jigsaws or saber saws. The sole plate 10 is connected to the housing of the portable power tool via fastening flanges 11, which are formed integrally on the sole plate 10.

Rollers 8 are mounted in a rotatable manner on the sole plate 10, said rollers 8 being located in the front and rear regions of the sole plate 10—as seen in the machining direction. A band 12 wraps around the rollers 8, said band 12 resting on the workpiece top side 4 during workpiece machining and being able to roll along the workpiece top side. As can be seen from the perspective illustrations according to FIGS. 4 and 5, such bands 12, which extend in the longitudinal direction and are wrapped around associated rollers 8, are in each case arranged in the left-hand and right-hand side region of the sole plate 10 on the underside.

Instead of a band 12, it is also possible to use a chain, which is wrapped around the rollers 8. In this case, the rollers 8 are expediently in the form of gearwheels.

In order to be able to influence the tensioning of the band 12, a tension roller 13 is arranged in a vertically displaceable manner on the sole plate 10, said tension roller 13 being vertically adjustable via a tensioning means 14 which is preferably configured as a tension disk. The tension roller 13 acts on the band 12 transversely to the plane of the band. Depending on the vertical position of the tension roller 13, to be set via the tensioning means 14, the tension in the band 12 rises or falls as a result.

FIGS. 6 to 8 show a further exemplary embodiment. FIG. 6 shows an individual illustration of the roller arrangement, which is integrated into a sole plate 10 (FIGS. 7 and 8). The roller arrangement consists of two shafts 9 that are offset in parallel, each shaft being a carrier of two rollers 8 in the left-hand and right-hand end-side end region. The rollers 8 are preferably connected to the shaft 9 so as to rotate therewith.

The two shafts 9 are connected together via a toothed belt 15, wherein rotational-speed synchronization of the shafts 9 or of the rollers 8 is achieved via the toothed belt 15. The toothed belt 15 is wrapped around a central section of each shaft 9, wherein, for slip-free transmission of movement, this central section is provided expediently with a friction-increasing surface, for example fluting, or optionally is also configured as a gearwheel.

FIG. 7 shows a view of the underside of the sole plate 10 having the integrated roller arrangement. The shafts 9 having the respective rollers 8, and also the connecting toothed belt 15 are each accommodated in cutouts which are introduced into the sole plate 10. This ensures, as can be seen in particular from FIG. 8, that only the rollers 8 protrude from the underside 10a of the sole plate 10 and thus come into contact with the workpiece top side during workpiece machining, but not the toothed belt 15.

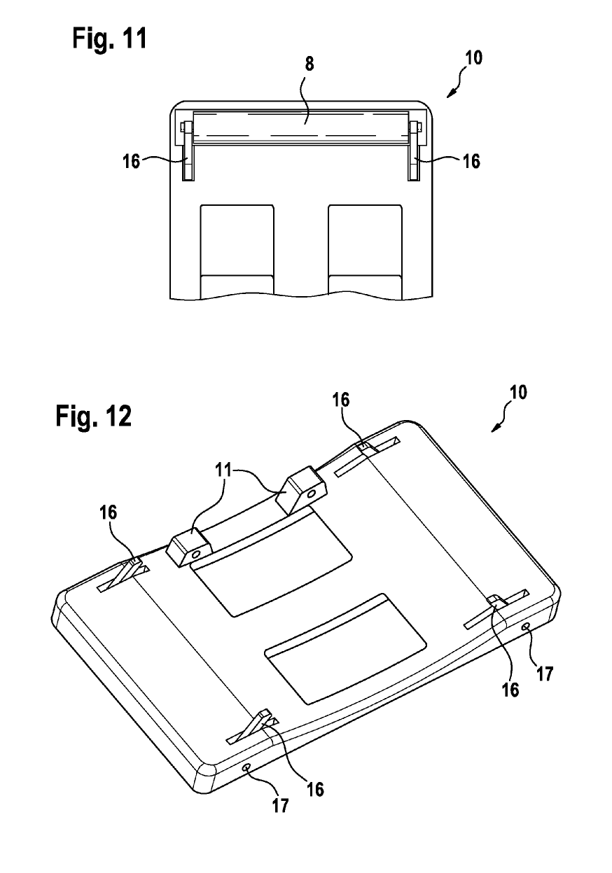

FIGS. 9 to 12 illustrate a further exemplary embodiment of a guide apparatus, in the form of a sole plate 10, in a portable power tool. FIG. 9 shows the sole plate in a side view, FIG. 10 in a perspective view illustrating the underside, FIG. 11 a view from below and FIG. 12 a perspective illustration of the top side.

The sole plate 10 has on its top side integrally formed fastening flanges 11 for fastening to the housing of the portable power tool. Rollers 8 protrude from the underside in the front and rear regions of the sole plate, such that, in the use position or operating position of the portable power tool, the rollers 8, rather than the underside of the sole plate 10, rest against the workpiece top side 4. As can be seen in particular from FIGS. 10 and 11, the rollers 8 in the front and rear regions of the sole plate 10 are each in the form of guide rolls which extend approximately over the width of the sole plate 10. For better contact with the workpiece top side, the rollers 8 have an elastic running surface, for example in the form of a rubber coating applied to the rollers. The two guide rolls 8, which are arranged adjacently to the front side and the rear edge of the sole plate 10, are mounted in the sole plate 10 in a rotatable manner independently of one another. There is no kinematic coupling via a wrapping band or belt or the like.

Each roller 8 is assigned an actuating lever 16 which is mounted on the sole plate 10 in a pivotable manner at an axle 17 and is connected to the roller 8 or is in contact therewith. The roller 8 is accommodated in a vertically adjustable manner in a cutout in the sole plate 10, such that the relative position of the roller 8 can be adjusted in relation to the underside of the sole plate 10. By pivoting the actuating lever 16 about the associated axle 17, the vertical position of the roller 8 in the sole plate 10 is set. In this case, each angular position of the actuating lever 16 is assigned precisely one defined vertical position of the roller 8. In this way, the protrusion of the roller 8 from the underside of the sole plate 10 can be set.

Each roller 8 has in each case one actuating lever 16 in the left-hand and right-hand side region, with the two actuating levers 16 per roller 8 being intended to be actuated independently of one another, as a result of which it is possible also to set inclined positions of the roller 8 with respect to the underside of the sole plate, wherein the rotation axis of the roller 8 is arranged at an angle to a central plane or the underside of the sole plate 10. Alternatively, embodiments in which only one actuating lever 16 is provided per roller 8 are possible.

The two rollers 8 in the front and rear regions of the sole plate 10 are intended to be set in a vertically adjustable manner independently of one another via respectively associated actuating levers 16.

1. A guide apparatus for portable power tools, comprising:
a guide part configured to be placed on a top side of a workpiece to be machined; and
a roller arrangement held on the guide part and configured to roll on the workpiece, the roller arrangement having at least one roller mounted in a rotating manner on the guide part.

2. The guide apparatus as claimed in claim 1, wherein the at least one roller includes at least two axially offset rollers.

3. The guide apparatus as claimed in claim 1, further comprising a band or a belt configured to wrap around the at least one roller.

4. The guide apparatus as claimed in claim 3, wherein, when in a use position, the band or belt extends along an underside of the guide part and rests against the workpiece top side.

5. The guide apparatus as claimed in claim 3, further comprising a tension roller mounted in a rotatable manner on the guide part and configured to rest against the band or belt.

6. The guide apparatus as claimed in claim 1, wherein the at least one roller includes at least one roller arranged in each side region of the guide part.

7. The guide apparatus as claimed in claim 6, wherein opposing rollers are arranged on a common shaft.

8. The guide apparatus as claimed in claim 1, wherein the at least one roller is held in a height-adjustable manner.

9. The guide apparatus as claimed in claim 1, wherein the guide part is a sole plate.

10. The guide apparatus as claimed in claim 1, wherein the guide part is a protective hood.

11. A portable power tool comprising:
a guide apparatus including:
a guide part configured to be placed on a top side of a workpiece to be machined; and
a roller arrangement held on the guide part and configured to roll on the workpiece, the roller arrangement having at least one roller mounted in a rotating manner on the guide part.
